(19) United States
(12) Patent Application Publication
(10) Pub. No.: US 2014/0093677 A1
(43) Pub. Date: Apr. 3, 2014

(54) COVER ELEMENT FOR FORMING FLOOR OR/AND WALL COVERINGS

(71) Applicant: ArsRatio Holding GmbH, Innsbruck (AT)

(72) Inventor: Claus Permesang, Munchen (DE)

(21) Appl. No.: 14/126,026

(22) PCT Filed: Apr. 12, 2012
(86) PCT No.: PCT/DE2012/100102

§ 371 Date: Dec. 13, 2013

(30) Foreign Application Priority Data
Jun. 28, 2011 (DE) 10 2011 078 160.9

(51) Int. Cl. E04F 13/08; B32B 3/06

(52) U.S. Cl. CPC E04F 13/0894; B32B 3/06; E04F 13/0866
USPC 428/99

(57) ABSTRACT

A covering element for forming floor and/or wall coverings, including connecting links, which protrude from two edges of the covering element that are perpendicular to one another and flush with the contact face thereof, and stepped recesses on the edges opposite the previously mentioned two edges for receiving the connecting links of such covering elements adjacent to the covering element in the floor and/or wall covering. The stepped recesses correspond to the connecting links. The covering element also has devices for fixing the connecting links in the stepped recesses receiving the connecting links. The protruding length of the connecting links is larger than the thickness of the covering element, and can amount to a multiple of the thickness of the covering element.

The invention relates to a cover element for forming floor or/and wall coverings, the cover element having connecting pieces which protrude from two edge sides, which edge sides of the cover element extend perpendicularly of each other flush with the placement side thereof, and stepped recesses corresponding to the connecting pieces at the aforementioned edge sides for receiving the connecting pieces of the cover elements adjacent to such cover elements in the floor or/and wall covering, as well as devices for affixing the connecting pieces in the stepped recesses which receive the connecting pieces.

Cover elements of this type are disclosed in PCT/EP2004/011843. In coverings formed of such elements, it may occur that the floor covers separate at the connecting locations between the cover elements, particularly when the ground is uneven and the total thickness of the cover elements is small.

The invention is based on the object of providing a novel cover element of the above mentioned type which can be subjected to higher loads.

The cover element according to the invention which meets this object is characterized in that the protruding length of the connecting pieces is greater than the thickness of the cover element.

As a result of the wide configuration of the connecting pieces of the present invention, greater holding forces are obtained because of increased the lever effect which prevents separation of the cover elements at the connecting locations. It is possible to prevent twisting of the cover elements relative to each other about vertical axes, as well as prevent pivoting movements of the cover elements relative to each other about horizontal axes.

In accordance with a preferred embodiment of the invention, the projecting length is greater than the thickness of the cover elements by at least the factor 1.2, preferably the factor 1.5. The stability of the coverings produced from the cover elements increases with increasing overlapping length.

In accordance with an embodiment of the invention, the protruding length of the connecting pieces is a multiple of the thickness of the cover element, and the connecting pieces extend in the stepped recesses of the adjacent cover element up to half the width of the cover elements. In the latter case, a similar stiffening effect is achieved when placing the plates in two layers, wherein the plates of one layer each overlap four plates of the other layer and are connected therewith.

Preferably, the connecting pieces and/or the stepped recesses extend laterally offset over the entire length or a portion of the length of the respective edge side of the plate element.

In an embodiment, the cover element has an upper decorative layer, a support layer which provides stability to the cover element on the placement side thereof, and an intermediate layer which connects the decorative layer to the support layer preferably by foaming or injection molding. The decorative and support layers can also be connected directly to each other, for example, by gluing.

Moreover, a border edging surrounding the decorative layer is advantageously foamed or injection molded, possibly around the decorative layer, and is preferably connected in one piece to the connecting pieces and is possibly connected to linings of the stepped recesses.

The connecting pieces and possibly the linings can preferably be formed in one piece onto the intermediate layer.

In accordance with another advantageous embodiment of the invention, the fixing devices are provided for mutually fixing the cover elements in the horizontal as well as the vertical directions in the floor or/and wall covering.

Advantageously, the fixing devices include at least one connecting groove parallel to the respective edge side, or a row of holes for engagement of a connection web, or a row of ppieces of an adjacent cover element.

The connecting web or ppieces may be capable of being locked or/and clamped in the connecting groove, or in the plug hole.

In accordance with another embodiment of the invention, an accumulation of the material forming the connecting pieces is provided in the bottom area of the connecting piece. This advantageously facilitates the formation of a connecting groove in the bottom area of the connecting pieces, wherein the connecting groove extends into the material accumulation.

A connecting web of an adjacent cover element can be hooked with a pivoting movement of the cover element into the connecting groove in the bottom area.

In accordance with a further development of the invention, the circumferentially extending border edging has a groove on edge sides of the cover element that extend perpendicularly to each other, and on the edge sides located opposite these edge sides is a web projection adapted to the groove.

In the following, the invention will be further explained with the aid of embodiments and the enclosed drawings which refer to these embodiments. In the drawing:

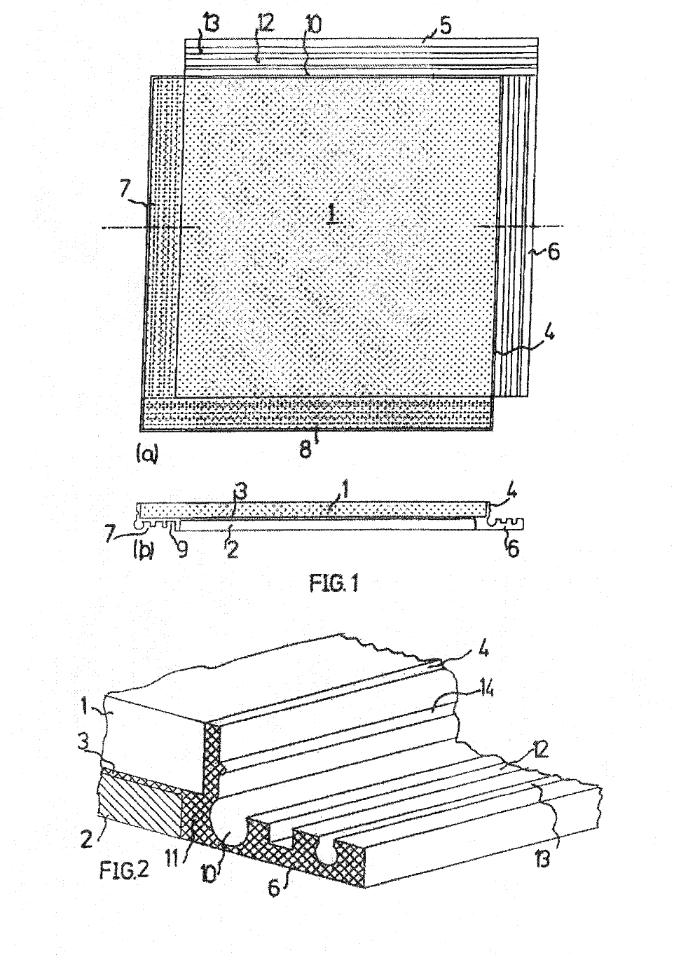

FIG. 1 shows a cover element according to the invention in a top view and a sectional side view.

FIG. 2 is a partial view of the cover element of FIG. 1.

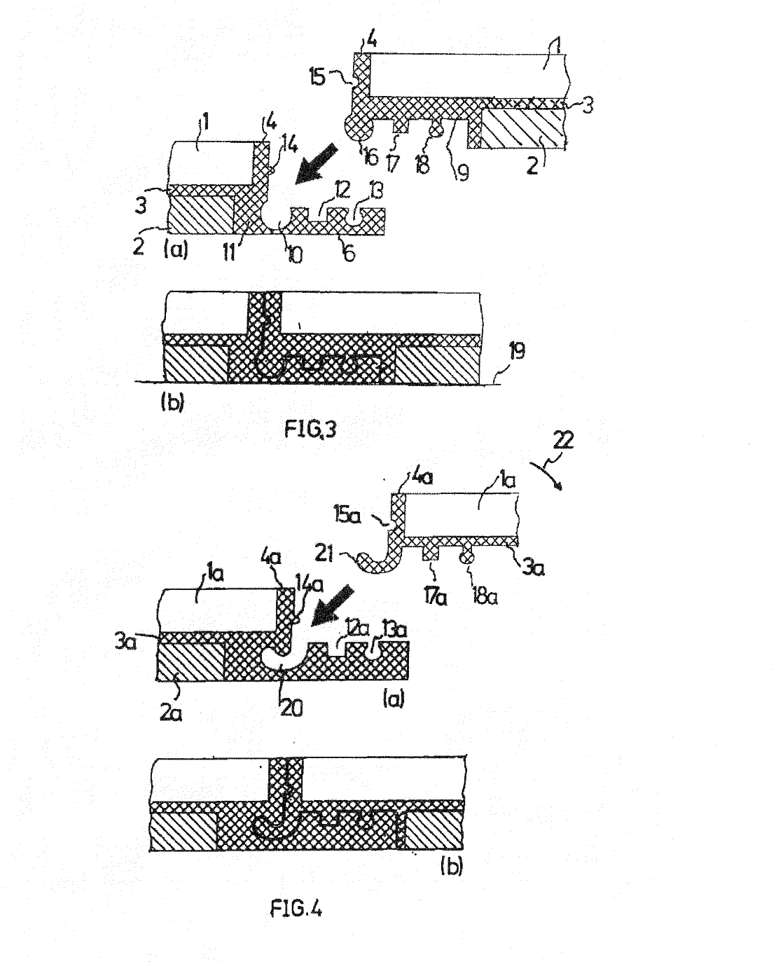

FIG. 3 is an illustration explaining the placement of the cover elements according to FIG. 1.

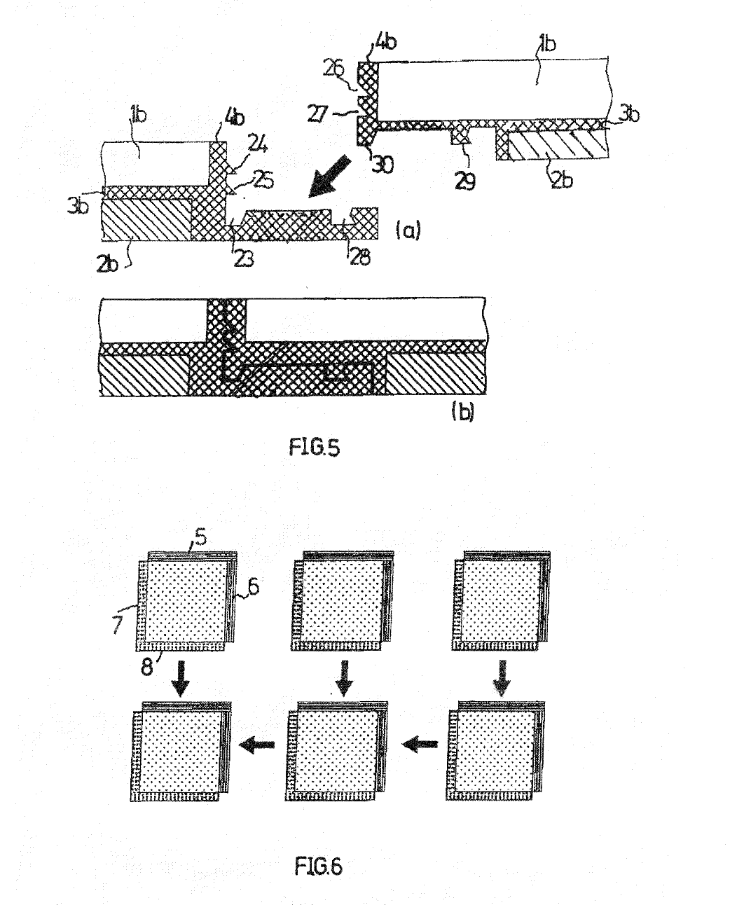

FIGS. 4 and 5 show further partial views of the cover elements explaining the placement of the cover elements according to the invention.

FIG. 6 is an illustration explaining the manufacture of a floor or/and wall lining of cover elements according to the preceding Figures.

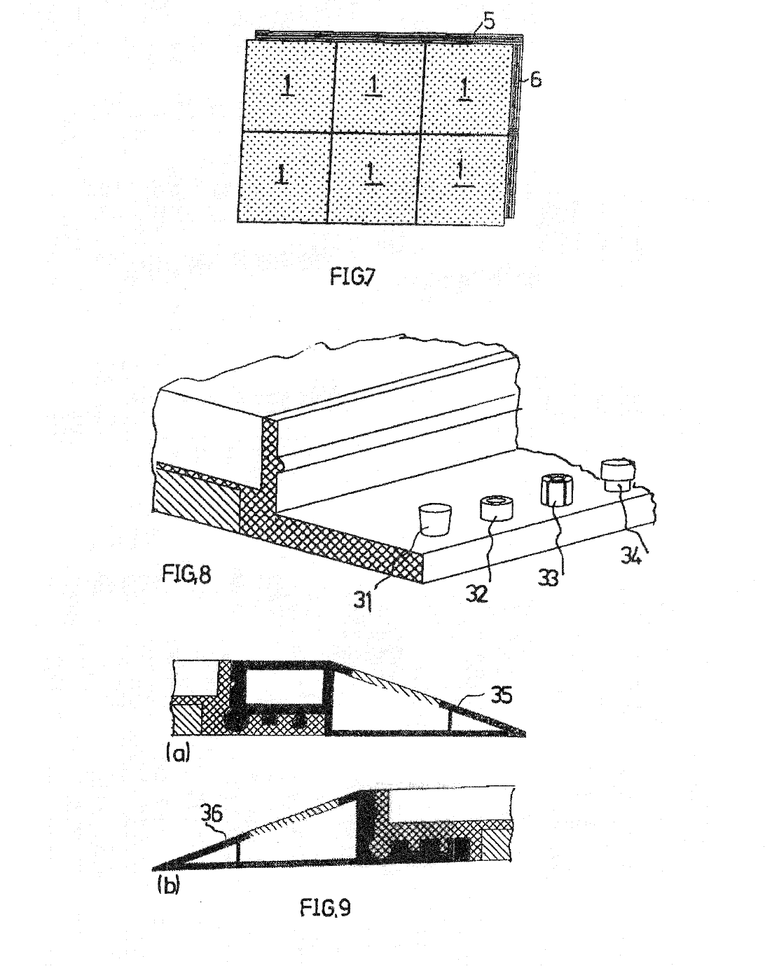

FIG. 7 shows a bottom or/and a wall cover of cover elements according to the preceding Figures.

FIG. 8 shows a further cover element according to the invention, with different fixing elements illustrated as examples, and

FIG. 9 shows border configurations of a floor or/and wall covering manufactured from cover elements according to the invention.

A cover element illustrated in FIG. 1 comprises a decorative layer 1 which consists, for example, of a ceramic or stoneware plate, a support layer 2 manufactured, for example, of synthetic recycling material, and an intermediate layer 3 arranged between the decorative layer 1 and the support layer 2. In the illustrated embodiment the intermediate layer 3 is injection molded or foamed to the decorative layer 1 with the use of a tool and consists of PU foam.

During injection molding or foaming, a border edging 4 circumferentially surrounding the decorative layer 1 and furthermore, a connecting pieces 5 or 6 each are formed on the intermediate layer 3 at two edge sides of the cover element that extend perpendicularly to each other.

On the edge sides which are located opposite the edge sides having the connecting pieces 5 or 6, stepped edges 7 and are formed having linings formed integrally with the intermediate layer 3 and a circumferential border edging 4 of which the lining 9 is visible in FIG. 1b.

The connecting pieces 5, 6 as well as the stepped edges 7, 8 complimentary thereto, extend each laterally offset over the entire length of the respective border side of the cover element.

The connecting pieces 5, 6 which are flush with the support side of the cover element, have in the bottom area thereof a connecting groove 10 which is rounded, for example, in the cross section, wherein the connecting groove 10 extends into a material accumulation 11 formed at the bottom of the connecting piece 5, 6 out of the material of the connecting piece. Next to the connecting groove 10 extending parallel to the respective border side, each of the connecting pieces 5, 6 has two additional connecting grooves 12 and 13 which extend parallel to each other and to the border side, of which the connecting groove 12 in the illustrated embodiment has a rectangular cross section and the connecting groove 13 is undercut by a rounded cross section. At the circumferentially extending border edging 4 a web projection 14 is formed extending over two border sides which extend perpendicularly of each other. A groove 15 at the edge sides of the border edging located opposite the aforementioned border edging corresponds in its cross section to the web projection 14 (FIG. 3a).

A rounded web pin 16 at the stepped recess on the side of the respective connecting groove corresponds to the connecting groove 10 on the side of the cover element located opposite the respective connecting groove, a web pin 17 corresponds to the connecting groove 12, and a web pin 18 corresponds to the connecting groove 13.

For forming a covering on a floor or wall surface 19 of the cover elements described above, the cover elements are joined in the manner indicated in FIG. 3a and FIG. 6, wherein the connecting pieces 5, 6 fill out stepped recesses 7, 8 of adjacent cover elements. In this connection, the web pins 16 and 18 engage in the connecting grooves 10 or 13. Adjacent cover elements in the floor covering or wall covering are thus fixed to each other horizontally as well as vertically. The web pins 17 inserted into the connecting grooves 12 only ensure fixing in a horizontal direction. The web 14 penetrating into the groove 15 ensures a sealing action between the abutting border edgings 4 of adjacent cover elements.

The width of the connecting pieces 5, 6, which is greater than the thickness of the cover elements, ensures a stable non-opening connection between the cover elements in the floor or/and wall surface. The connecting pieces 5, 6 rest flush on the floor or wall surface 19 and the stepped recesses 7, 8 are completely filled out by the connecting pieces 5, 6. The connections between the cover elements are still capable of bearing vertical loads. The cover elements cannot rotate relative to each other either about their horizontal or vertical axes.

In the embodiments discussed below, equal components or equally acting components are denoted by the same reference numeral as in the preceding embodiment, wherein the letter a, b, etc. is added to the respective reference number.

The embodiment of FIG. 4 differs from the preceding embodiment in that instead of the connecting groove 10, which has an approximately circular cross section, a connecting groove 20 is provided which is capable of insertion of a hook shaped connecting web 21. Accordingly, in this manner, another cover element can be placed against an already placed cover element during a pivoting movement indicated by an arrow 22. In the end phase a web pin 18a engages in a connecting groove 13a.

In an embodiment illustrated in FIG. 5 a connecting groove 23 with trapezoidal cross section is formed in the bottom area of the connecting piece, wherein a correspondingly shaped web pin 30 corresponds to the oppositely located stepped recess. Two web projections 24 and 25 formed at a border edging 4b which extend perpendicular to each other are constructed as barbed hooks. Corresponding grooves 26, 27 are formed at the circumferential border edging 4b located opposite the respective border sides. Another connecting groove 28 near the free end of the connecting pieces is undercut. In it a corresponding web pin 29 engages at the stepped recess.

FIG. 8 shows, by way of example, that instead of connecting grooves and web pins, round pins and corresponding rows of holes could also be used, wherein four differently constructed pins 31 to 34 are shown in FIG. 8.

For laterally limiting floor or/and wall coverings manufactured from the above described cover elements, ramp ledges 35, 36 illustrated in FIG. 9 can be used, wherein the ramp ledges 35 can be used at border sides with connecting pieces and the ramp ledges 36 can be used at edge sides with stepped recesses.

1-14. (canceled)

15. A cover element for forming floor and/or wall coverings, comprising: a support side; two edge sides that extend perpendicular to each other; connecting pieces that protrude from the two edge sides so as to be flush with the support side; stepped recesses, corresponding to the connecting pieces, arranged at edge sides located opposite the two edge sides for receiving the connecting pieces of cover elements adjacent to the cover element in the floor or/and wall covering; and devices for fixing the connecting pieces in the stepped recesses, wherein a protruding length of the connecting pieces is greater than a thickness of the cover element.

16. The cover element according to claim 15, wherein the protruding length of the connecting pieces is greater than the thickness of the cover element by at least a factor of 1.2.

17. The cover element according to claim 16, wherein the protruding length of the connecting pieces is greater than the thickness of the cover element by a factor of 1.5.

18. The cover element according to claim 15, wherein the protruding length of the connecting pieces is a multiple of the thickness of the cover element, and the connecting pieces extend in the stepped recesses in the adjacent cover elements up to half a width of the stepped recesses.

19. The cover element according to claim 15, wherein the connecting pieces and/or the stepped recesses extend laterally offset over an entire length or a portion of the length of a respective edge side of the cover element.

20. The cover element according to claim 15, wherein the cover element has an upper decorative layer, a support layer on the support side, and an intermediate layer that connects the decorative layer with the support layer.

21. The cover element according to claim 20, further comprising a border edging peripherally extending around the decorative layer, wherein the border edging is connected integrally with the connecting pieces.

22. The cover element according to claim 21, wherein border edging is connected integrally with linings of the stepped recesses.

23. The cover element according to claim 22, wherein the connecting pieces and the linings are integrally connected to the intermediate layer.

24. The cover element according to claim 15, wherein the fixing devices are provided for mutually horizontally and vertically fixing the cover elements in the floor and/or wall coverings.

25. The cover element according to claim 15, wherein the fixing devices have at least one connecting groove extending parallel to the respective edge side and/or a row of holes for engagement of a connecting web or of a plug pin of an adjacent cover element in the floor and/or wall covering.

26. The cover element according to claim 25, wherein the connecting web or the plug pins are engagable and/or clampable in the connecting groove or the plug holes.

27. The cover element according to claim 15, wherein an accumulation of a material forming the connecting pieces is provided in a bottom area of the connecting pieces.

28. The cover element according to claim 27, wherein a connecting groove is provided in the bottom area of the connecting pieces, and the connecting groove extends into the material accumulation.

29. The cover element according to claim 28, wherein a connecting web of an adjacent cover element can be hooked by a pivoting movement of the adjacent cover element into the connecting groove provided in the bottom area of the cover element.

30. The cover element according to claim 21, wherein the peripheral border edging at two edge sides of the cover element that extend perpendicular to each other has a web projection and edge sides opposite the two edge sides have a groove.

31. The cover element according to claim 20, wherein the intermediate layer connects the decorative layer with the support layer by foaming or injection molding.

32. The cover element according to claim 23, wherein the connecting pieces and the linings are connected to the intermediate layer by foaming or injection molding.
